(19) United States
(12) Patent Application Publication
(10) Pub. No.: US 2026/0350642 A1
(43) Pub. Date: Nov. 5, 2026

(54) GENERATING INVENTORY TASKS USING MACHINE-LEARNING MODELS AND UPDATING ITEM AVAILABILITY FOR ONLINE SYSTEM

(71) Applicant: Maplebear Inc., San Francisco, CA (US)

(72) Inventor: Erica Jazayeri Quintana, San Francisco, CA (US)

(21) Appl. No.: 19/195,608

(22) Filed: Apr. 30, 2025

(51) Int. Cl. G06Q 30/0202; G06Q 10/0635; G06Q 10/087

(52) U.S. Cl. CPC G06Q 30/0202; G06Q 10/0635; G06Q 10/087

(57) ABSTRACT

A system determines, in real-time, whether to check the status of an item that is marked “out-of-stock” in an online system. The system obtains a set of inventory files that mark a set of items that are out-of-stock. For each item of the set of items that are marked out of stock, the system generates an expected risk value for the item based on an extracted set of features associated with the item. The system selects a subset of the items according to a ranking of the set of items. For each selected item of the subset of items, the system determines whether to transmit a check status request to a user of the system. The system receives a response from the user including an availability of the item at a retailer location.

### BACKGROUND

An online system receives periodic updates on a set of inventory files for retailer locations indicating a set of items that are out of stock. The set of inventory files are typically updated based on item stock counts taken at fixed intervals, often during non-peak hours, such as early morning or overnight. While this approach provides a baseline understanding of product availability, this approach does not account for dynamic changes in inventory throughout the day. Retailer locations may frequently restock items throughout the day. Current online systems, however, lack the technological infrastructure to receive such dynamic inventory updates throughout the day, leading to the online system's inventory files becoming outdated, some items may be inaccurately marked as “out of stock” (OOS) or “likely out of stock,” even when they may have been restocked. The delay or absence of dynamically updated inventory files can lead to several challenges: users may abandon orders if their desired items are unavailable, online systems may experience friction when integrating inventory files between retailer locations and online systems, and the overall efficiency of the fulfillment process may be diminished.

### SUMMARY

In accordance with one or more aspects of the disclosure, the online system determines whether to submit a real-time task to check the status of an item that is marked “out-of-stock.” The online system may obtain a set of inventory files that mark a set of items that are out-of-stock. For each item of the set of items that are marked out of stock, the online system may extract a set of features associated with the item. The set of features may include a description of the item, item cost, item order rate, search rate, and repurchase rate. For each item of the set of items that are marked out of stock, the online system may generate an expected risk value for the item by applying machine-learning models to the extracted set of features. The online system may rank the set of items marked out-of-stock according to the generated expected risk values. The online system may select a subset of the items according to the ranking of the set of items. For each selected item of the subset of items, the online system may generate an expected cost of assigning a picker to check a status of an availability of the item. For each selected item of the subset of items, the online system determines whether to transmit a check status request to a picker associated with the online system. The check status request may include a prompt for a picker to perform an item availability check of the item. The online system may receive a response from the picker including an image of the selected item or an availability of the item at a retailer location.

### BRIEF DESCRIPTION OF THE DRAWINGS

FIG. 1A illustrates an example system environment for an online system, in accordance with some embodiments.

FIG. 1B illustrates an example system environment for an online system, in accordance with some embodiments.

FIG. 2 illustrates an example system architecture for an online system, in accordance with some embodiments.

FIG. 3 illustrates a flowchart for applying a machine-learning model to determine whether to generate a status check task and updating an item's availability, in accordance with some embodiments.

FIG. 4 illustrates an example of a user interface presented to reflect the updated availability of the set of items, in accordance with one or more embodiments.

FIG. 5 is a flowchart illustrating a process for updating an item availability, in accordance with some embodiments.

### DETAILED DESCRIPTION

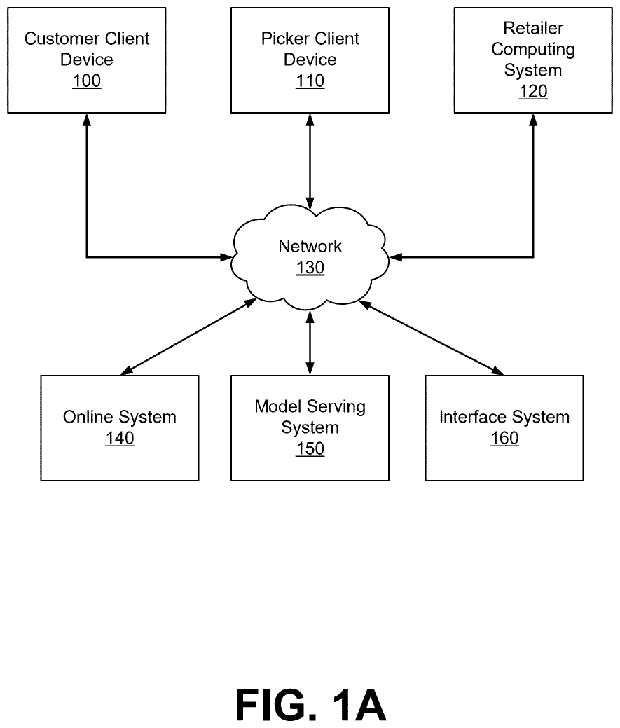

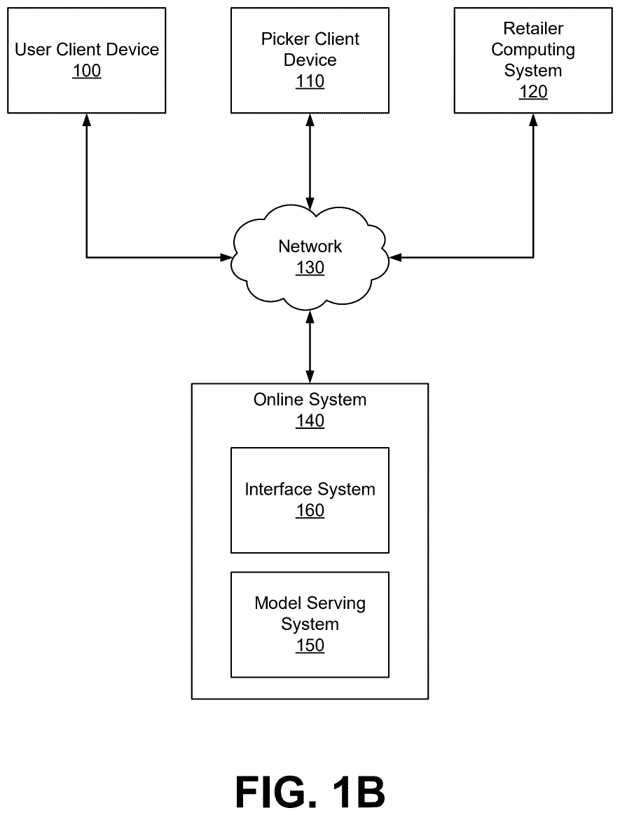

FIG. 1A illustrates an example system environment for an online system 140, in accordance with some embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

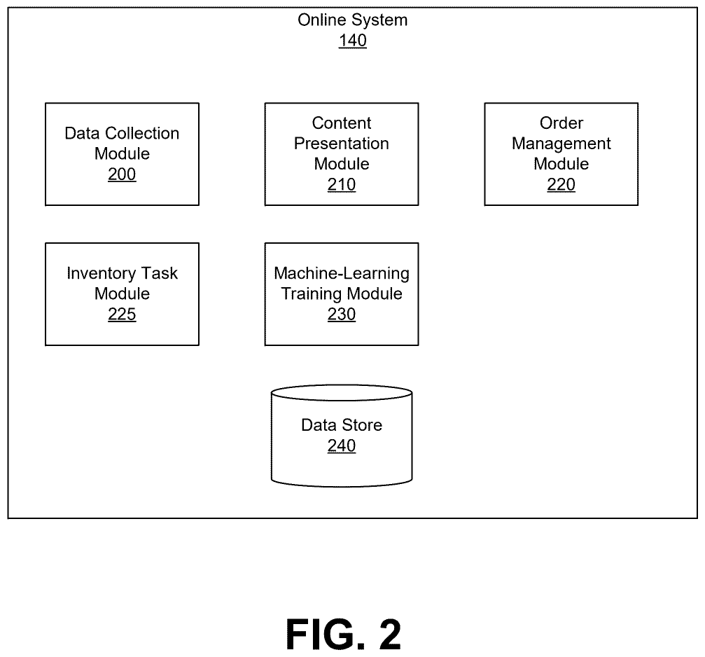

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 receives periodic updates on a set of inventory files for retailer locations indicating a set of items that are “out of stock” (OOS). The set of inventory files are typically updated based on item stock counts taken at fixed intervals, often during non-peak hours, such as early morning or overnight. While this approach provides a baseline understanding of product availability, this approach does not account for dynamic changes in inventory throughout the day. Retailer locations may frequently restock items throughout the day. Current online systems, however, lack the technological infrastructure to receive such dynamic inventory updates throughout the day, leading to the online system's inventory files becoming outdated, some items may be inaccurately marked as “out of stock” or “likely out of stock,” even when they may have been restocked. The delay or absence of dynamically updated inventory files can lead to several challenges: users may abandon orders if their desired items are unavailable, online systems may experience friction when integrating inventory files between retailer locations and online systems, and the overall efficiency of the fulfillment process may be diminished.

Therefore, in one or more embodiments, the online system 140 described herein provides dynamic and real-time inventory updates by managing the availability of items marked as OOS within a set of inventory files, and generating status check tasks for picker users based on one or more machine-learning models. For each item of a set of items that are flagged as OOS in a respective inventory file, the online system 140 may analyze a set of features associated with the item and the inventory files to determine which item of the set of OOS items have a higher degree of risk value and would benefit from an item availability status update. In one or more embodiments, a higher risk value for an item marked OOS or likely OOS may indicate a level of risk associated with the item if the item was marked out of stock all day with respect to lost revenue, lost gross transaction value (GTV), and the like. The online system 140 may identify a subset of the set of OOS items to create a check-status task for picker users. These tasks may then be assigned to a picker, who verifies the availability of the selected items and updates the online system 140 accordingly.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

In one or more embodiments, for an order of a user, the online system 140 performs a query to a machine-learned model for pairing information. Specifically, the online system 140 provides external data relating to the pairing of alcohol and food to the model serving system 150. The online system 140 provides a request to the model serving system 150 to infer alcohol pairings for the order given the list of items and previous user shopping history for the user. The online system 140 receives a response to the prompt from the model serving system 150 based on execution of the machine-learned model. The online system 140 obtains the response and includes the external pairing data in the personalized recommendations for alcohol pairings to the user. In some embodiments, the online system 140 uses the external pairing data to sort the list of potential alcohol candidates into a final recommendation.

FIG. 1B illustrates an example system environment for an online system 140, in accordance with some embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The inventory task module 225 provides dynamic and real-time inventory updates by managing the availability of items marked as “out of stock” (OOS) within a set of inventory files. For each item of a set of items that are flagged as OOS, the inventory task module 225 may analyze a set of features associated with the item and the inventory files to determine which item of the set of OOS items require an item availability status update. The inventory task module 225 may identify a subset of the set of OOS items for which a check-status task should be created. The inventory task module 225 may offer such tasks to a picker, who verifies the availability of the subset of the set of OOS items. The inventory task module 225 may receive such updates and adjust the availability of the items marked OOS accordingly.

Traditional online systems often rely on static inventory data from retailer locations, which provide a snapshot of inventory levels at specific points in time—typically once per day. However, this approach introduces significant challenges in dynamic retail environments where stock levels can change rapidly due to user purchases, in-store restocking, or supplier deliveries. Traditional online systems 140 may utilize predictive models to estimate the likelihood of restocking an item for each warehouse location by taking into account unique inventory profiles, store layouts, and restocking schedules. This approach, however, requires large-scale operations across thousands of retailer locations, leading to computational inefficiencies and increased operational costs. Furthermore, the sole reliance on such predictive models to estimate the likelihood that an item is restocked may lead to inaccuracies due to variations in real-world conditions, such as unexpected delays in restocking or supplier disruptions.

The inventory task module 225 may address such challenges by leveraging in-store pickers to provide real-time updates. A set of predictive models may determine the risk for a set of items that are marked as OOS if an item's inventory status is left unchecked. The predictive model may receive as input a set of features, including inventory files specific to each retailer location. These inventory files may include information such as item related data, current stock levels, historical restocking patterns, and delivery schedules. As an example, the features may include item related data such as item cost, buy-it-again rates, item order rates, and search rates. The inventory task module 225 may prioritize such high-risk OOS items thereby reducing the computational complexity of such predictive models by eliminating the need to evaluate irrelevant items. Further, by prioritizing a subset of the set of items that are marked as OOS, the inventory task module 225 ensures that resources are used effectively.

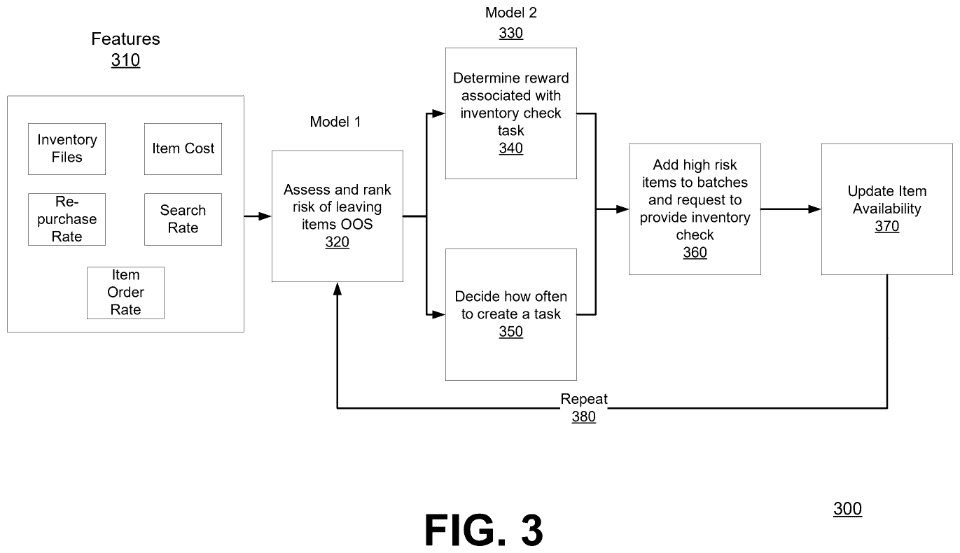

FIG. 3 illustrates a flowchart for applying a machine-learning model to determine whether to generate a status check task and updating an item's availability, in accordance with some embodiments. In some arrangements, one or more steps shown in FIG. 3 may be performed by inventory task module 225, shown in FIG. 2.

The inventory task module 225 obtains one or more inventory files associated with a retailer location. The inventory files may include data related to items such as item details and stock levels. The inventory files may include a marked set of items that are out of stock.

For each item of the set of items that are marked out of stock, the inventory task module 225 may extract a set of features 310 associated with the item. In one or more embodiments, the set of features for an item may include at least one or a combination of a description of the item, item cost, item order rate, search rate, and a repurchase rate.

The inventory task module 225 may receive as input the extracted features for each item of the set of items to assess and rank an expected risk value for each item by applying one or more machine-learning models to the extracted set of features. The risk value is a quantitative measure that assesses the potential impact of an OOS item remaining unavailable, incorrectly, for an extended period, such as all day. The risk value may be calculated based on factors like the item's order rate, which reflects its demand, and the financial loss associated with missed sales for the item, including the item's daily gross transaction value (GTV) and the GTV of abandoned carts caused by the item's absence. Additionally, the risk value may consider whether the item is an “anchor” item that drives additional purchases, amplifying the consequences of its unavailability.

In one or more embodiments, the inventory task module 225 may generate an expected risk value for each item of the set of items that are marked OOS by applying a first ML model to determine a likelihood that the item of the set of items is back in stock. The first ML model may receive as input historical restock data and supplier data for the item. As an example, the likelihood that an item for chocolate chip cookies is restocked may be high with a 0.7 likelihood based on historical restock data related to the item.

In one or more embodiments, the inventory task module 225 determines an expected gain from each item of the set items that are marked OOS by applying the first ML model or another ML model to determine an expected gain, wherein the expected gain is an expected number or amount of sales for the item when it is available in stock. The ML model may receive as input historical sales data, search rates, item order rates, and repurchase rates for the item. As an example, the expected gain for when chocolate chip cookies are restocked may be high with an expected gain of 50 units sold per day.

For each item of the set of items, the inventory task module 225 may compute a total expected value according to the computed likelihood that the item is back in stock and the expected gain for the item. For example, the total expected value may be computed by multiplying the likelihood and the expected gain for the item. The expected risk value may be proportional to the total expected value (e.g., negative of the expected value).

In one or more embodiments, the first ML model may be configured as a neural network architecture, any of the architectures described above such as a transformer architecture. The inventory task module 225 may train parameters of the first ML model by creating a training dataset including a set of training examples. Specifically, a training example may include the respective set of features such as item-level ordering data, item cost, search rate, and repurchase rate for each zone of an item that was previously identified to have been OOS, and a corresponding risk value for the item that characterizes the risk or cost of leaving the item OOS for the days that the item was OOS. For example, the inventory task module 225 may utilize the prior week's item-level ordering data, item cost, search rate, and repurchase rate at the zone level to analyze which OOS items were “anchor” items (cart starters), and the associated risk and cost of leaving the items OOS for the days they were out of stock. Such data may be used to construct the training data.

Oftentimes, there are secondary warehouses in the same zone where the user will find available inventory, and the batching system will usually route the picker to the store with the best inventory levels for that user's order. In one or more embodiments, the inventory task module 225 identifies one or more OOS items for an order where there is no secondary location with the inventory, or the order is a pickup order where another store cannot be considered. The inventory task module 225 obtains the set of features and risk values for OOS items in such orders to construct the training data for further fine-tuning or training the parameters of the first ML model. Since there is no alternate warehouse, the OOS items in these situations may have a higher degree of accuracy of risk than other cases.

In one or more embodiments, the inventory task module 225 generates a plurality of training examples based on the training data described above, where a training example may include a training set of features for a respective item and a known risk value for the item. Subsequently, the inventory task module 225 applies parameters of the one or more machine-learning models to the training set of features to generate an estimated risk value. The inventory task module 225 backpropagates one or more terms from a loss function indicating a difference between the estimated risk value and the known risk value to update the parameters of the one or more machine-learning models.

For each item of the set of items, the inventory task module 225 assesses and ranks 320 the risk of leaving an item OOS. In one embodiment, the inventory task module 225 ranks the set of items by the generated expected risk values.

Based on the ranking, the inventory task module 225 may select a subset of the items, wherein the subset of items are selected according to the determined ranking for the set of OOS items. The inventory task module 225 may select the subset of items based on a threshold of expected risk value of the set of items.

The inventory task module 225 may determine which item of the subset of items to check status of the availability of the item by applying a second ML model 330 to each item of the subset of items to generate the expected cost for offering a picker to check a status of the availability of the item, wherein the expected cost is generated based on the expected risk value of the selected item.

The inventory task module 225 may decide 340 a reward associated with an inventory check task to offer a picker via the picker client device 110 by applying a second ML model 330 to each item of the subset of items to determine the expected cost for offering the check status task for the item. As an example, the ML model may receive as inputs, features such as the expected risk value for the item as determined by the first ML model, historical check status cost data for offering a check status request for the item, item data type, and ease of checking the status of the item. In one or more embodiments, the ML model may determine a reward to offer a picker to check the item availability status of an item based on the expected value for offering a check status task for the item. As an example, the inventory task module 225 may offer a higher offer for a picker based on a greater expected value of the item.

In one or more embodiments, the inventory task module 225 may apply a machine learning model to determine the likelihood that the picker with the associated picker client device 110 will accept the offer to check the status of the item. The machine learning model may receive as input related historical check status request data including information on whether the picker accepted the offer, item related data, and picker related data. As an example, the ML model may determine that a specific picker, e.g., User A has a 60% likelihood of accepting an offer to check the status of an item for $10 when checking the status of an item within the same retailer location.

The inventory task module 225 also decides 350 how often to create a check status request. The inventory task module 225 may apply the second ML model 330 or another ML model to determine how often (i.e., frequency) to transmit a check status request according to the item. As an example, an item such as XXY Sparkling Water may be typically restocked within three hours after being marked as out-of-stock. Based on this, the update item module 225 may use the ML model to determine the optimal interval for transmitting check status requests. In this case, the inventory task module 225 might decide to schedule the task for transmitting instructions for a picker with a picker client device 110 to repeat a specified number of times or at a regular interval throughout the day for the XXY Sparkling Water.

The inventory task module 225 identifies whether to transmit a check status request to a picker client device 110. The inventory task module 225 performs 360 a status check for the highest risk items. In one or more embodiments, for each item of the subset of items, the inventory task module 225 identifies whether to transmit the check status request for an item by computing an expected total value by subtracting the computed risk value from the determined cost value of submitting a check status request for an item. As an example, the inventory task module 225 may transmit a check status request for items with a computed total value above a predetermined threshold value.

For the identified items, the inventory task module 225 adds high risk items to batches and transmits instructions to the picker client device 110 to cause display of a check status request for the identified items on a display of picker client device 110. In one or more embodiments, the check status request includes a user interface with a prompt for the picker to perform an item availability check of the selected item. The inventory task module 225 receives a response from the picker, wherein the response includes an image of the selected item (e.g., as captured using an image capture device of picker client device 110) or an availability of the item at a retailer location. Responsive to determining that the identified item is back in stock, the availability of the item may be indicated by a number of items actually in stock for the identified item. As an example, for an identified Brand X Root Beer item, the response may include an image of the item at the aisle where the Brand X Root Beer is located and a verification that the Brand X Root Beer is back in stock, with 17 units available at the retailer location.

The inventory task module 225 updates 370 item availability according to the received response. The inventory task module 225 updates the inventory files and the catalog database to reflect the updated availability of the selected item at the retailer location. The inventory task module 225 repeats 380 the process above, assessing and ranking the risk of leaving a modified or new set of items OOS. The inventory task module 225 transmits instructions to a user client device 100 to cause display of a user interface that presents the selected item and the updated availability of the selected item at the retailer location.

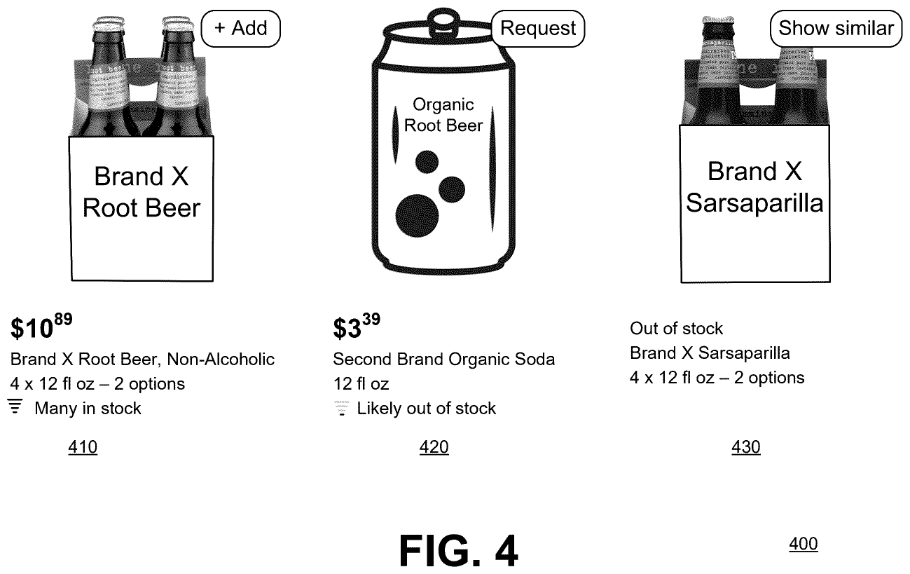

FIG. 4 illustrates an example of the user interface presented to reflect the updated availability of the set of items, in accordance with one or more embodiments. The inventory task module 225 may present a user interface to the user via the user client device 100 that indicates the updated availability of the selected item at the retailer location. As an example, Brand X Root Beer 410, Second Brand Organic Soda 420, and Brand X Sarsaparilla 430 may have been all OOS items initially. The inventory task module 225 may transmit instructions for a picker to perform a check status task on the following items, as described in conjunction with FIG. 3. The inventory task module 225 may receive an indication from a picker device that the Brand X Root Beer 410 is back in stock with a larger number of units. The Brand X Root Beer 410 is updated accordingly including an indication that many are currently in stock. The inventory task module 225 may receive an indication that the Second Brand Organic Soda 420 is back in stock but with a few units. The inventory task module 225 may update the Second Brand Organic Soda 420 to be back in stock with an option to request the item, wherein the item is likely out of stock. As a final example, the inventory task module 225 may receive an indication that Brand X Sarsaparilla 430 is still out of stock, the Brand X Sarsaparilla 430 is left with an OOS user interface indication.

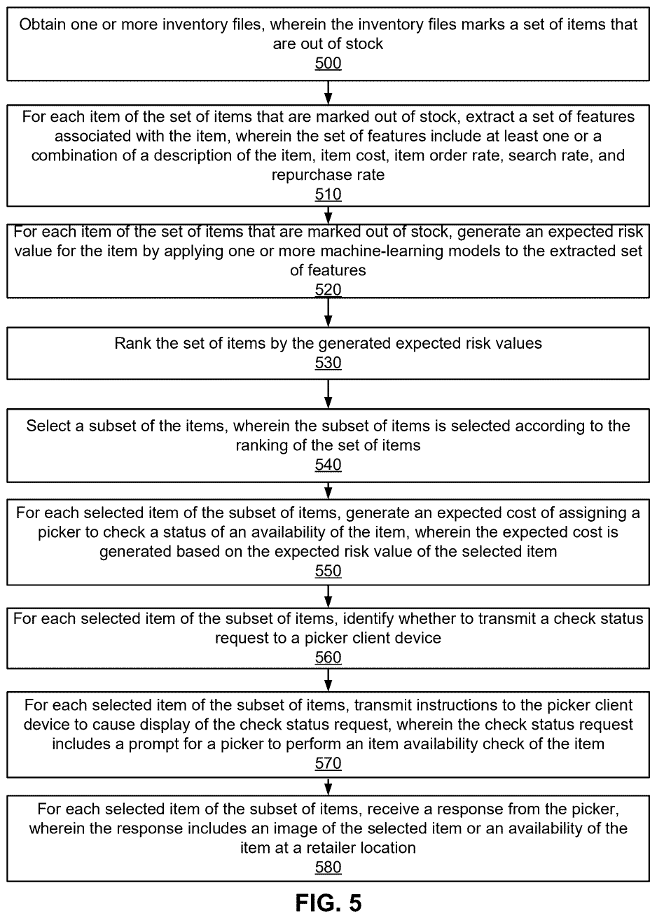

FIG. 5 is a flowchart illustrating a process for updating item availability in accordance with some embodiments. Alternative embodiments may include more, fewer, or different steps from those illustrated in FIG. 5 and the steps may be performed in a different order from that illustrated in FIG. 5. These steps may be performed by an online system (e.g., online system 140). Additionally, each of these steps may be performed automatically by the online system 140 without human intervention.

The inventory task module 225, may obtain 500 one or more inventory files, wherein the inventory files mark a set of items that are out of stock. The inventory task module 225, for each item of the set of items that are marked out of stock, may extract 510 a set of features associated with the item, wherein the set of features includes at least one or a combination of a description of the item, item cost, item order rate, search rate, and repurchase rate. The inventory task module 225, for each item of the set of items that are marked out of stock, may generate 520 an expected risk value for the item by applying one or more machine-learning models to the extracted set of features. The inventory task module 225 may rank 530 the set of items by the generated risk values. The inventory task module 225 may select 540 a subset of the items, wherein the subset of items is selected according to the ranking of the set of items. For each selected item of the subset of items, the inventory task module 225 may generate 550 an expected cost of assigning a picker to check a status of an availability of the selected item, wherein the expected cost is generated based on the expected risk value of the selected item. For each selected item of the subset of items, the inventory task module 225 may identify 560 whether to transmit a check status request to a picker client device. For each item of the subset of items identified for a status check, the inventory task module 225 may transmit 570 instructions to the picker client device to cause display of the check status request, wherein the check status request includes a prompt for a picker to perform an item availability check of the item. For each item of the subset of items identified for a status check, the inventory task module 225 may receive 580 a response from the picker client device 110, wherein the response includes an image of the selected item or an availability of the selected item at a retailer location.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
obtaining one or more inventory files, wherein the inventory files mark a set of items that are out of stock;
for each item of the set of items that are marked out of stock:
extracting a set of features associated with the item, wherein the set of features include at least one or a combination of a description of the item, item cost, item order rate, search rate, and repurchase rate, and
generating an expected risk value for the item by applying one or more machine-learning models to the extracted set of features; and
ranking the set of items by the generated expected risk values;
selecting a subset of the items, wherein the subset of items is selected according to the ranking of the set of items;
for each selected item of the subset of items:
generating an expected cost of assigning a picker to check a status of an availability of the selected item, wherein the expected cost is generated based on the expected risk value of the selected item;
identifying whether to transmit a check status request to a picker client device;
transmitting instructions to the picker client device to cause display of the check status request, wherein the check status request includes a prompt for a picker to perform an item availability check of the item; and
receiving a response from the picker, wherein the response includes an image of the selected item or an availability of the selected item at a retailer location.

2. The method of claim 1, wherein generating the expected risk value by applying the one or more machine-learning models further comprises:
determining a likelihood that the item of the set of items is back in stock; and
determining an expected gain from the item, wherein the expected gain is a number or amount of sales when the item is available in stock.

3. The method of claim 1, wherein identifying whether to transmit the check status request further comprises:
computing an expected total value by subtracting the expected risk value from the expected cost of submitting the check status request.

4. The method of claim 1, wherein the availability of the selected item specifies a number of the selected item in stock at the retailer location.

5. The method of claim 1, wherein when the response indicates that the availability of the selected item in the retailer location is back in stock, the method further comprising:
updating a catalog database to reflect the updated availability of the selected item to indicate that the selected item is back in stock.

6. The method of claim 1, further comprising:
transmitting instructions to a user device to cause display of a user interface, wherein the user interface presents the selected item and an updated availability of the selected item at the retailer location.

7. The method of claim 6, wherein the user interface includes an indication of a likelihood probability that the item is out of stock.

8. The method of claim 1, further comprising:
for each selected item of the subset of items:
generating a timing or frequency of the check status request of the selected item, and
transmitting instructions for the check status request to the picker client device based on the timing or frequency.

9. The method of claim 1, further comprising:
generating a plurality of training examples, a training example including a training set of features for a respective item and a known risk value for the item; applying parameters of the one or more machine-learning models to the training set of features to generate an estimated risk value; and
backpropagating one or more terms from a loss function indicating a difference between the estimated risk value and the known risk value to update the parameters of the one or more machine-learning models.

10. A non-transitory computer-readable storage medium storing computer instructions, the computer instructions, when executed by one or more processors, cause the one or more processors to perform operations further comprising:
obtaining one or more inventory files, wherein the inventory files mark a set of items that are out of stock;
for each item of the set of items that are marked out of stock:
extracting a set of features associated with the item, wherein the set of features include at least one or a combination of a description of the item, item cost, item order rate, search rate, and repurchase rate, and
generating an expected risk value for the item by applying one or more machine-learning models to the extracted set of features; and
ranking the set of items by the generated expected risk values;
selecting a subset of the items, wherein the subset of items is selected according to the ranking of the set of items;
for each selected item of the subset of items:
generating an expected cost of assigning a picker to check a status of an availability of the selected item, wherein the expected cost is generated based on the expected risk value of the selected item;
identifying whether to transmit a check status request to a picker client device;
transmitting instructions to the picker client device to cause display of the check status request, wherein the check status request includes a prompt for a picker to perform an item availability check of the item; and
receiving a response from the picker, wherein the response includes an image of the selected item or an availability of the selected item at a retailer location.

11. The non-transitory computer-readable storage medium of claim 10, wherein the computer instructions to generate the expected risk value by applying the one or more machine-learning models, when executed by the one or more processors cause the one or more processors to perform operations further comprising:
determining a likelihood that the item of the set of items is back in stock; and
determining an expected gain from the item, wherein the expected gain is a number or amount of sales when the item is available in stock.

12. The non-transitory computer-readable storage medium of claim 10, wherein the computer instructions to identify whether to transmit the check status request, when executed by the one or more processors cause the one or more processors to perform operations further comprising:
computing an expected total value by subtracting the expected risk value from the expected cost of submitting the check status request.

13. The non-transitory computer-readable storage medium of claim 10, wherein the availability of the selected item specifies a number of the selected item in stock at the retailer location.

14. The non-transitory computer-readable storage medium of claim 10, wherein the computer instructions, when executed by the one or more processors cause the one or more processors to perform operations further comprising:
generating a plurality of training examples, a training example including a training set of features for a respective item and a known risk value for the item;
applying parameters of the one or more machine-learning models to the training set of features to generate an estimated risk value; and
backpropagating one or more terms from a loss function indicating a difference between the estimated risk value and the known risk value to update the parameters of the one or more machine-learning models.

15. A computer system comprising:
a processor; and
a non-transitory computer readable storage medium storing instructions that, when executed by the processor, cause the processor to perform actions comprising:
obtaining one or more inventory files, wherein the inventory files mark a set of items that are out of stock;
for each item of the set of items that are marked out of stock:
extracting a set of features associated with the item, wherein the set of features include at least one or a combination of a description of the item, item cost, item order rate, search rate, and repurchase rate, and
generating an expected risk value for the item by applying one or more machine-learning models to the extracted set of features; and
ranking the set of items by the generated expected risk values;
selecting a subset of the items, wherein the subset of items is selected according to the ranking of the set of items;
for each selected item of the subset of items:
generating an expected cost of assigning a picker to check a status of an availability of the selected item, wherein the expected cost is generated based on the expected risk value of the selected item;
identifying whether to transmit a check status request to a picker client device;
transmitting instructions to the picker client device to cause display of the check status request, wherein the check status request includes a prompt for a picker to perform an item availability check of the item; and
receiving a response from the picker, wherein the response includes an image of the selected item or an availability of the selected item at a retailer location.

16. The computer system of claim 15, wherein generating the expected risk value by applying the one or more machine-learning models further comprises:
determining a likelihood that the item of the set of items is back in stock; and
determining an expected gain from the item, wherein the expected gain is a number or amount of sales when the item is available in stock.

17. The computer system of claim 15, wherein identifying whether to transmit the check status request further comprises:
computing an expected total value by subtracting the expected risk value from the expected cost of submitting the check status request.

18. The computer system of claim 15, wherein the availability of the selected item specifies a number of the selected item in stock at the retailer location.

19. The computer system of claim 15, wherein when the response indicates that the availability of the selected item in the retailer location is back in stock, the computer system further comprising:
updating a catalog database to reflect the updated availability of the selected item to indicate that the selected item is back in stock.

20. The computer system of claim 15, further comprising:
generating a plurality of training examples, a training example including a training set of features for a respective item and a known risk value for the item;
applying parameters of the one or more machine-learning models to the training set of features to generate an estimated risk value; and
backpropagating one or more terms from a loss function indicating a difference between the estimated risk value and the known risk value to update the parameters of the one or more machine-learning models.
